(19) United States
(12) Patent Application Publication
(10) Pub. No.: US 2002/0062269 A1
(43) Pub. Date: May 23, 2002

(54) Method and system for providing real time customer service

(76) Inventors: Syed Kirmani, Norwalk, CT (US); Lynn Allard, Stamford, CT (US); Rob Lisch, Mason, OH (US); Scott Mulloy, Stamford, CT (US); Tiffany Hartzell, Alexandria, VA (US); Chris Hatchett, Atlanta, GA (US); Janine Movish, Liberty Township, OH (US); Paul Kurtz, Atlanta, GA (US)

Correspondence Address: David A. Fox, Esq., Cantor Colburn LLP, 55 Griffin Road South, Bloomfield, CT, 06002, US

(21) Appl. No.: 09/752,021

(22) Filed: Dec. 28, 2000

Related U.S. Application Data
(60) Provisional application No. 60/252,095, filed on Nov. 20, 2000.

(51) Int. Cl. G06F 17/60

(52) U.S. Cl. 705/35

(57) ABSTRACT

An exemplary embodiment of the invention is a method for providing customer service to a consumer of a credit product. The method includes receiving a service request from a consumer and performing an automated security check in response to the service request. The service request is processed in real time upon satisfying the security check and a database is updated in real time upon completion of said service request.

### CROSS REFERENCE TO RELATED APPLICATIONS

This application claims the benefit of U.S. Provisional application 60/252,095, filed Nov. 20, 2000, the entire contents of which are incorporated herein by reference.

### BACKGROUND

The invention relates generally to a method and system for providing customer service and in particular to a method and system for providing on-line, real time customer service for a credit card account. Many credit card providers provide for on-line customer service through which a customer uses a network (e.g., the Internet) to contact a customer service system to submit a service request. The service request may include changing the address associated with an account, requesting a change in credit limit, reporting a card lost, etc. In conventional systems, the service request from the customer is placed in an e-mail queue and is distributed to customer service personnel via electronic techniques. The customer service personnel then effectuate the service request (e.g. change of address requested by the customer). This may require 2-3 days until customer service personnel receive the service request entered in the e-mail queue. Thus, there is a lack of real-time implementation of the service request submitted by the consumer.

### BRIEF SUMMARY

An exemplary embodiment of the invention is a method for providing customer service to a consumer of a credit product. The method includes receiving a service request from a consumer and performing an automated security check in response to the service request. The service request is processed in real time upon satisfying the security check and a database is updated in real time upon completion of said service request.

### BRIEF DESCRIPTION OF THE DRAWINGS

FIG. 1 is a block diagram of a customer service system in one embodiment of the invention.

FIG. 2 depicts an exemplary user interface.

FIG. 3 illustrates an exemplary flow chart of the system operation.

### DETAILED DESCRIPTION

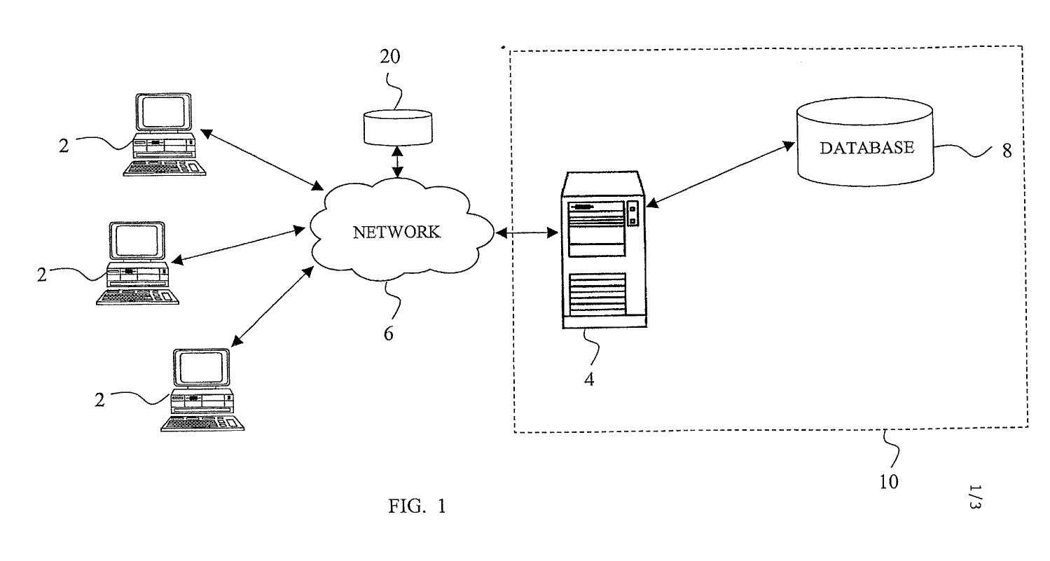

FIG. 1 is a block diagram of a customer service system in one embodiment of the invention. The system includes one or more consumer systems 2 coupled to a host system 10 via a network 6. Each consumer system 2 may be implemented using a general-purpose computer executing a computer program for carrying out the processes described herein. The network 6 may be any type of known network including a local area network (LAN), wide area network (WAN), global network (e.g., Internet), intranet, extranet, etc. The consumer systems 2 may be coupled to the host system 10 through multiple networks (e.g., intranet and Internet) so that not all consumer systems 2 are coupled to the host system 10 via the same network. One or both of the consumer systems 2 and the host system 10 may be connected to the network 6 in a wireless fashion and network 6 may be a wireless network. In a preferred embodiment, the network 6 is the Internet and consumer system 2 executes a user interface application (e.g., web browser) to contact the host system 10 through the network 6. Alternatively, a consumer system 2 may be implemented using a device programmed primarily for accessing network 6 such as WebTV or a network computer.

The host system 10 includes a processor, such as a server 4 operating in response to a computer program stored in a storage medium accessible by the server. The server 4 may operate as a network server (often referred to as a web server) to communicate with the consumer systems 2. The server 4 handles sending and receiving information to and from consumer systems 2 and can perform associated tasks. The server 4 may also include a firewall to prevent unauthorized access to the host system 10 and enforce any limitations on authorized access. The firewall may be implemented using conventional hardware and/or software as is known in the art.

The server 4 also operates as an applications server. The server 4 executes one or more computer programs to interact with a database 8. It is understood that separate servers may be used to implement the network server functions and the applications server functions. Alternatively, the network server, firewall and the applications server can be implemented by a single server executing computer programs to perform the requisite functions.

Database 8 contains a variety of information related to consumer's credit account. In one embodiment of the invention, the host system is operated by a credit card provider and the database 8 includes information concerning account holders and their accounts. The database 8 may be contained in a legacy, mainframe system maintained by the credit card provider. Server 4 may interact with database 8 through existing legacy components. Changes to database 8 can be made dynamically, in real time to instantaneously update information contained in the database 8. Thus, a consumer's service request is processed immediately by server 4 without human intervention.

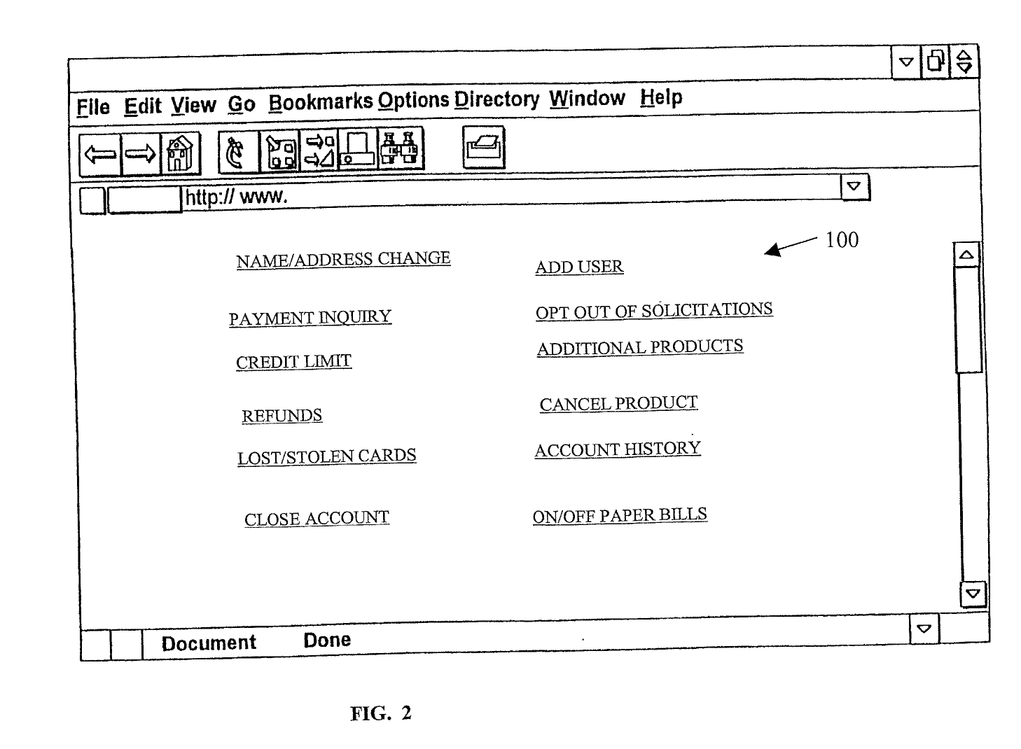

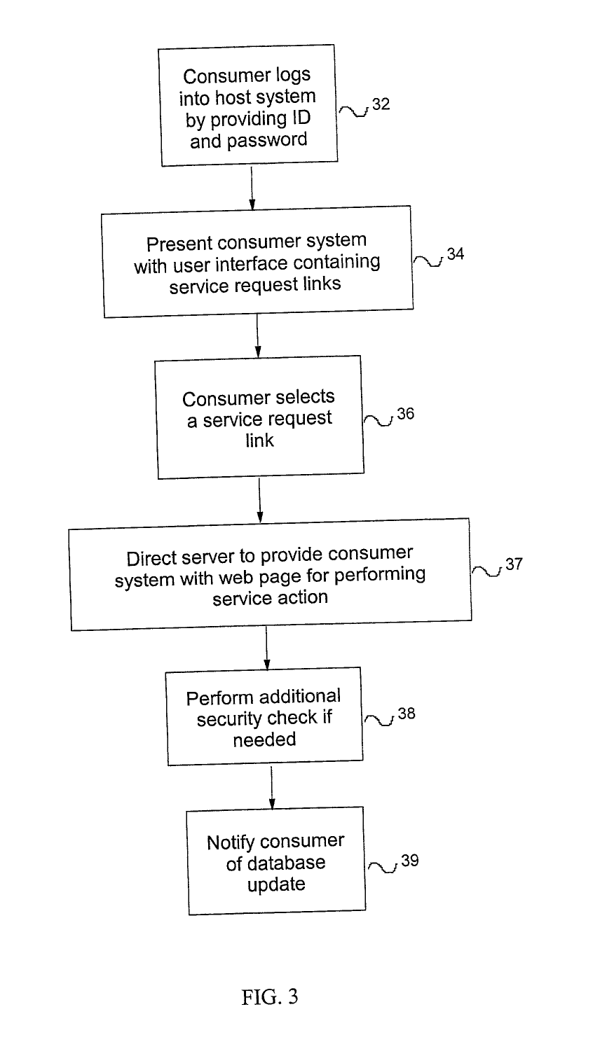

Referring to FIG. 3, operation of the system will now be described. As noted above, the consumer system 2 may execute a user interface application (e.g., web browser) to interact with server 4. The consumer may need to log into the host system 10 by providing a user identification and password at step 32, as is known in the art. Once a consumer logs in, the consumer system 2 is presented with a user interface (such as that shown in FIG. 2) at step 34. The main user interface of FIG. 2 identifies a number of service request links 100 which direct the consumer system 2 to different web pages provided by server 4 for performing service actions. Each of the service requests is implemented in real time by server 4 and cause an immediate update to database 8. For example, the consumer may select the change address link to change the mailing address for a credit card account at step 36. Selecting this link directs the server 4 to provide the consumer system 2 with a web page for entering a new address at step 37. Note that certain requests may require additional security checks at step 38. Such additional security checks may utilize an interactive fraud bureau product to confirm specific information about the consumer. If the security check allows the update, server 4 immediately alters the consumer's mailing address in database 8 and notifies the consumer system 2 of the change at step 39. There is no need for human intervention in the form of customer service personnel. The other service requests depicted in FIG. 2 also occur in real time without customer service personnel intervention once the appropriate security confirmation has been made.

The server 4 may implement a variety of security checks depending on the nature of the service request. A first form of security verification is the use of consumer information for verification of access. For example, the consumer may be prompted to enter information such as account number, zip code, social security number and/or telephone number to verify that the request from consumer system 2 can be processed. The information provided from consumer system 2 can be compared to information stored in database 8 to authorize the service request. A higher level of security can be obtained by creating a robust security system that uses the consumer account number and a PIN. Again, the account number and PIN can be compared to records in database 8 to authorize the service request. As discussed, additional security may be obtained by accessing third party databases 20 coupled to network 6. For example, if a consumer requests a change of address, an interactive fraud bureau product can be accessed over network 6 to confirm a home address. Alternatively, if the consumer requests an increase in credit limit, a credit rating database can be accessed over network 6 to confirm credit history. Accordingly, the security aspect is not limited to information stored in database 8 of host system 10.

To perform the enhanced security check, the consumer may be requested to answer a number of questions as prompted by host system 10. For example, if the consumer requests a change of address, the host system 10 prompts the consumer to identify the consumer's mortgage company. The consumer may respond through either pre-defined answers (e.g., drop down menus, radio buttons, etc.) or through user-defined answers. The host system 10 then accesses the appropriate third party database 20 based on the consumer's responses.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A system for providing customer service to a consumer of a credit product, the system comprising:
a processor integrated with said system for receiving a service request from a consumer, performing an automated security check in response to said service request, performing said service request in real time upon satisfying said security check, and updating a database in real time upon completion of said service request;
a network coupled to said processor; and
said database coupled to said processor for storing data relating to said system.

2. The system of claim 1, further including a third party database coupled to said network.

3. The system of claim 1, wherein said service request includes a link for performing a service action corresponding to said service request.

4. The system of claim 1, further including said processor sending a consumer notification upon completion of said service request.

5. The system of claim 1, wherein said security check includes receiving security information from said consumer and comparing said security information to information in said database.

6. The system of claim 5, wherein said receiving said security information from said consumer includes receiving personal information corresponding to said consumer.

7. The system of claim 5, wherein said receiving said security information from said consumer includes receiving a password corresponding to said consumer.

8. The system of claim 2, wherein said processor accesses said third party database to perform said security check.

9. The system of claim 8, wherein said security check includes receiving security information from said consumer and comparing said security information to information in said third party database.

10. The system of claim 9, wherein said receiving said security information from said consumer includes receiving personal information corresponding to said consumer.

11. The system of claim 9, wherein said receiving said security information from said consumer includes receiving a password corresponding to said consumer.

12. A method for providing customer service to a consumer of a credit product, the method comprising:
receiving a service request from a consumer;
performing an automated security check in response to said service request;
performing said service request in real time upon satisfying said security check; and
updating a database in real time upon completion of said service request.

13. The method of claim 12, wherein said service request includes a link for performing a service action corresponding to said service request.

14. The method of claim 12, further including sending a consumer notification upon completion of said service request.

15. The method of claim 12, wherein said security check includes receiving security information from said consumer and comparing said security information to information in said database.

16. The method of claim 15, wherein said receiving said security information from said consumer includes receiving personal information corresponding to said consumer.

17. The method of claim 15, wherein said receiving said security information from said consumer includes receiving a password corresponding to said consumer.

18. The method of claim 12, further including accessing a third party database.

19. The method of claim 18, wherein said security check includes receiving security information from said consumer and comparing said security information to information in said third party database.

20. The method of claim 19, wherein said receiving said security information from said consumer includes receiving personal information corresponding to said consumer.

21. The method of claim 19, wherein said receiving said security information from said consumer includes receiving a password corresponding to said consumer.

22. A storage medium encoded with machine-readable computer program code for providing customer service to a consumer of a credit product, said storage medium including instructions for causing a processor to implement the method comprising:
receiving a service request from a consumer;
performing an automated security check in response to said service request;
performing said service request in real time upon satisfying said security check; and
updating a database in real time upon completion of said service request.

23. The storage medium of claim 22, wherein said service request includes a link for performing a service action corresponding to said service request.

24. The storage medium of claim 22, further including instructions for causing said processor to implement sending a consumer notification upon completion of said service request.

25. The storage medium of claim 22, wherein said security check includes receiving security information from said consumer and comparing said security information to information in said database.

26. The storage medium of claim 25, wherein said receiving said security information from said consumer includes receiving personal information corresponding to said consumer.

27. The storage medium of claim 25, wherein said receiving said security information from said consumer includes receiving a password corresponding to said consumer.

28. The storage medium of claim 22, further including instructions for causing said processor to implement accessing a third party database.

29. The storage medium of claim 28, wherein said security check includes receiving security information from said consumer and comparing said security information to information in said third party database.

30. The storage medium of claim 29, wherein said receiving said security information from said consumer includes receiving personal information corresponding to said consumer.

31. The storage medium of claim 29, wherein said receiving said security information from said consumer includes receiving a password corresponding to said consumer.

32. A computer data signal encoded with machine-readable computer program code for providing customer service to a consumer of a credit product, said computer data signal comprising code configured to cause a processor to implement the method comprising:
receiving a service request from a consumer;
performing an automated security check in response to said service request;
performing said service request in real time upon satisfying said security check; and
updating a database in real time upon completion of said service request.

33. The computer data signal of claim 32, wherein said computer data signal is embodied in a carrier wave.

34. The computer data signal of claim 32, wherein said computer data signal is unmodulated.

35. The computer data signal of claim 32, wherein said service request includes a link for performing a service action corresponding to said service request.

36. The computer data signal of claim 32, further including code configured to cause said processor to implement sending a consumer notification upon completion of said service request.

37. The computer data signal of claim 32, wherein said security check includes receiving security information from said consumer and comparing said security information to information in said database.

38. The computer data signal of claim 37, wherein said receiving said security information from said consumer includes receiving personal information corresponding to said consumer.

39. The computer data signal of claim 37, wherein said receiving said security information from said consumer includes receiving a password corresponding to said consumer.

40. The computer data signal of claim 32, further including code configured to cause said processor to implement accessing a third party database.

41. The computer data signal of claim 40, wherein said security check includes receiving security information from said consumer and comparing said security information to information in said third party database.

42. The computer data signal of claim 41, wherein said receiving said security information from said consumer includes receiving personal information corresponding to said consumer.

43. The computer data signal of claim 41, wherein said receiving said security information from said consumer includes receiving a password corresponding to said consumer.
